(19) United States
(12) Patent Application Publication
(10) Pub. No.: US 2026/0155893 A1
(43) Pub. Date: Jun. 4, 2026

(54) OMNIDIRECTIONAL COMMUNICATION DEVICE

(71) Applicant: Vortexon Inc., Dover, DE (US)

(72) Inventor: Eric Stephen Rees Bullock, Austin, TX (US)

(73) Assignee: Vortexon Inc., Dover, DE (US)

(21) Appl. No.: 19/411,405

(22) Filed: Dec. 8, 2025

Related U.S. Application Data
(63) Continuation-in-part of application No. 17/729,248, filed on Apr. 26, 2022, now Pat. No. 12,518,906.

(51) Int. Cl. H04B 10/50; H04B 10/548

(52) U.S. Cl. CPC H04B 10/501; H04B 10/548

(57) ABSTRACT

A unified multimodal resonant communication and sensing device integrates electromagnetic, optical, plasma, acoustic, and charged particle interactions within a single omnidirectional architecture. A central resonant core made of plasma, gas, vapor, optical gain material, nonlinear crystal, or hybrid multimodal media is housed within a vessel surrounded by inductive coils, optical coils, electromagnetic coils, and external antennas for signal transmission and reception. These components generate controlled electromagnetic and photonic fields, impart rotational motion to the core, and establish a stabilized plasma environment that enhances resonance behavior. An optical cavity and an optically pumped magnetometer interrogate the medium to detect resonance based optical, magnetic, or electromagnetic signatures. Charged particle emitters and field gradient devices support energy excitation. A signal injection circuit introduces data for transmission, while rotation within the plasma and optical coil fields modulates signals. A programmable controller coordinates multimodal excitation for communication, sensing, photon generation, and particle beam signaling.

### CROSS-REFERENCE TO RELATED APPLICATIONS

This application is a continuation-in-part of U.S. patent application Ser. No. 17/729,248 filed Apr. 26, 2022, which claims priority to U.S. Provisional Application No. 63/179,664 filed Apr. 26, 2021. The subject matter disclosed herein that was previously disclosed in the parent applications retains its original priority date. Any newly added matter is entitled only to the filing date of this continuation-in-part application.

### RELATED APPLICATIONS

This application claims priority to the provisional patent application filed on Apr. 26, 2021, and assigned provisional patent app. No. 63/179,664.

### BACKGROUND

Communication devices permit data to be transmitted and received at different locations. For example, a transmitter device may transmit data at one location, which a receiver device receives at another location. A communication device may be able to function as both a transmitter device and a receiver device,

so that it can both send and receive communication from another device. A communication device may be communicatively connected to a host computing device that provides the data to be transmitted by the communication device, and that receives the data that has been received by the communication.

### BRIEF DESCRIPTION OF THE DRAWINGS

FIG. 1 is a front view diagram of an example omnidirectional communication device.

FIG. 2 is a top view diagram of the example omnidirectional communication device of FIG. 1, in which the high voltage coils and the inductor coils are depicted in detail.

FIG. 3 is a diagram of an example central core of the omnidirectional communication device of FIG. 1

### DETAILED DESCRIPTION

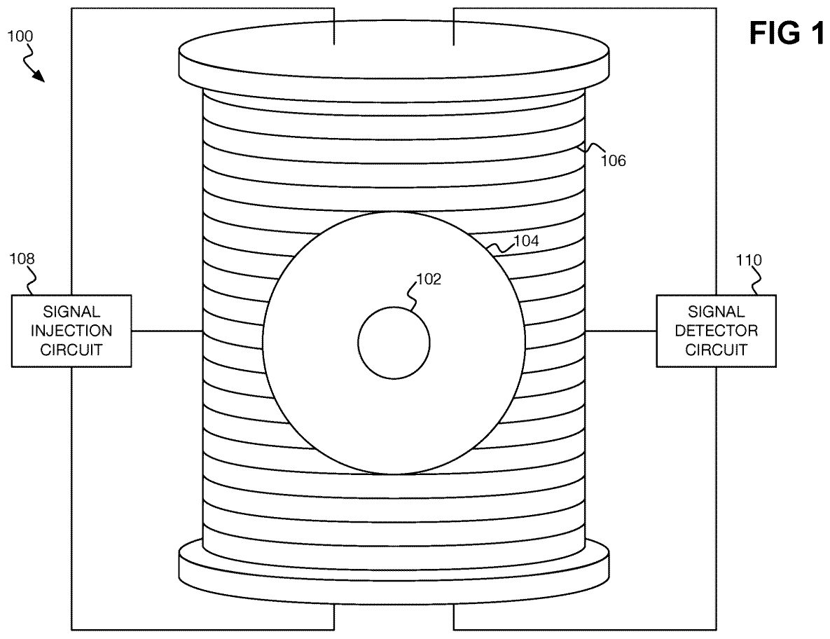

FIG. 1 shows a front view of an example omnidirectional communication device 100. The communication device 100 includes a central core 102, inductor coils 104, and high voltage coils 106. In the depicted example, the high voltage coils 106 can be cylindrical, whereas the inductor coils 104 can be ring, loop, or toroidal in shape, although they can also be spherical. The top and bottom of the device 100 may be or include radio frequency coils (i.e., loop antennas), such as Helmholtz coils but which also can produce signal throughout the device. Helmholtz coils can also be implemented externally to measure magnetic field.

The communication device 100 further includes a signal injection circuit 108 in an implementation in which the device 100 is to transmit a signal in accordance with data that may be encrypted or unencrypted. The communication device 100 can in addition or instead include a signal detector circuit 110 in an implementation in which the device 100 is to receive a signal that has been transmitted in accordance with data that may be encrypted or decrypted. The device 100 therefore can include either or both of the circuits 108 and 110. The circuits 108 and 110 are depicted in block form, but in actuality may be located on the sides and/or the top and bottom of the device 100. The circuits 108 and 110 may be directly mounted around the device 100 or mounted to a removable or permanent spherical or toroidal cavity resonator, such as shell resonator, and pointed at the central core 102 of the device 110. Further, the device 100 may function as a radio repeater.

Either or both of the circuits 108 and 110 can be or include one or multiple devices that work together. For example, the detector circuit 110 may be one or multiple devices that work together to receive or intercept a signal from inside and/or outside the device. Examples of such a detector circuit 110 include silicon avalanche diodes, photodiodes, laser diodes, scintillators, antennas, photodetectors, magnetometers, photomultiplier tubes, flat-panel detectors, microchannel plate detector, magnetic pickups, inductive sensors, resonant coils antennas, image sensors, optical sensors, and transducers. Furthermore, the signal injection circuit 108 may receive data from modems, oscillators, antennas, fiber optic cables and/or satellites.

The high voltage coils 106 generates a plasma field within which the central core 102 and the inductor coils 104 rotate. In another implementation, the high voltage coils 106 may be removed, to utilize just the inductor coils 104 and the central core 102 in an open system having zero confinement or traps, in which case magnetic confinement and/or homogeneous magnetic fields may be used as traps. The inductor coils 104 surround the central core 102. The inductor coils 104 generate electromagnetic fields within and impart gyroscopic spin to the central core 102.

In the case of signal transmission, the signal injection circuit 108 introduces a signal into the omnidirectional communication device 100 in accordance with data to be transmitted. That is, the signal represents the data to be transmitted, such as via the data being encoded within the signal. Rotation of the central core 102 and the inductor coils 104 within the plasma field warp the signal. This causes the central core 102 to omnidirectionally transmit the signal outside the communication device 100.

In the case of signal receipt, the central core 102 receives an omnidirectionally signal transmitted from outside of the communication device 100 in accordance with data. That is, the signal represents data, such as via the data being encoded within the signal. Rotation of the central core 102 and the inductor coils 104 within the plasma field warp the signal. The signal detector circuit 110 detects the signal as has been warped, such that the data is received. In another example, the inductor coils 104 may be modulated with the received signal, with the signal detector circuit 110 then detecting the signal as modulated.

More generally, different techniques can be used to send and receive data (i.e., signals). Such techniques include infrared transmission and detection, radio frequency transmission and detection, photonic transmission and detection, and electron and/or particle transmission and detection. In the infrared technique, infrared diodes, emitters, transmitters, and/or receivers may be employed. In the radio frequency technique, antennas, Helmholtz coils, microwave transmitters, and/or magnetrons may be employed. In the photonic technique, photo emitters, photoelectric diodes, pumped lasers, and/or laser diodes may be employed. In the electron and/or particle technique, particle accelerators, electron guns, magnetic lens, and/or electrostatic lens may be employed.

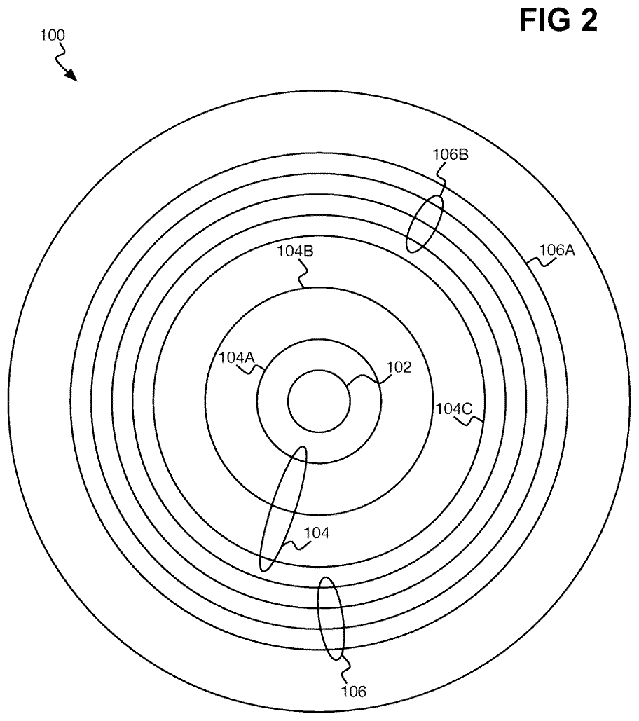

FIG. 2 shows a top view of the example omnidirectional communication device 100, in which the high voltage coils 106 and the inductor coils 104 are depicted in detail. As noted above, in the depicted example, the high voltage coils 106 are cylindrical. By comparison, in the depicted example, the inductor coils 104 are ring, loop, or toroidal in shape, as also noted above, but can instead be spherical.

The high voltage coils 106 includes a primary high voltage coil 106A and one or multiple secondary high voltage coils 106B. The high voltage coils 106 generate a high frequency electrostatic plasma field as the plasma field in question. An example of the voltage of the coils 106 is between 1 kilovolt and 12 million volts, and an example of the frequency of the resultant electrostatic plasma field is between 50 kilohertz and 10 gigahertz. The high voltage coils 106 can also be referred to as resonant transformers. The coils 106 may have a modulated driving circuit having a frequency range between 1 hertz and 60 gigahertz, if not higher. The coils 106 are tunable and can be driven at all frequency in the radio frequency domain. The driving circuit for the coils 106 may include or be connected to a signal detection circuit, an oscillator, a software-defined radio, an amplifier/rectifier, and/or a feedback circuit. In one implementation, the high voltage coils 106 may nevertheless be adjusted to accept low voltage alternating or direct current from 0.01 millivolts or higher if needed.

The primary high voltage coil 106A may be a helical coil, such as a helical resonator. The coil 106A may be an electromagnetic coil (i.e., a loading or primary coil) used as a radio wave resonator or filter, to induce voltage as well as signal into the inductor coils 104 as well as the secondary high voltage coils 106B. The primary high voltage coil 106A may have resonant inductive coupling with the secondary coils 106B, the inductor coils 104, and the central core 102. The helical resonator may include one coil or multiple coils, which can be single or multifilar, and which can be tunable to adjust the resonance, impedance and inductance. The shape of the coils may be cylindrical, spherical, toroidal, square or any other shape and can be arranged in various topologies. The helical resonator along with the secondary high voltage coils 106B make a series of resonant transformers that can send and receive signal from high voltage discharge. The secondary coils 106B coils can be arranged in various topologies and can form part of the circuits 108 and 110.

The gyroscopic electromagnetic fields generated by the inductor coils 104 within the central core 102 use the high frequency electrostatic plasma field generated by the high voltage coils 106. In the case of signal transmission, the high frequency electrostatic plasma field traps particles and anti-particles of the central core 102 for transmission by the electromagnetic fields, resulting in transmission of the signal. Helmholtz coils may be employed to create a penning trap to measure and trap particles within the device 100 for as long as possible. In the case of signal receipt, the high frequency electrostatic plasma field traps particles and anti-particles received by the central core 102 according to the signal, resulting in receipt of the signal.

The high voltage coils 106 can be wound around a framework that surrounds and supports the inductor coils 104 and the central core 102 in the center. The inductor coils 104 may be inductively coupled to the high voltage coils 106, electrically connected to a control circuit using slip rings, or by using rotary transformers. There may be feedback circuits connected to each coil 106 to collect data for processing and storage by a host computing device to which the communication device 100 is connected. Each high voltage coil 106 may be controlled via a corresponding high voltage coil circuit, specifically by controlling voltage and current applied to the coil 106 and by modulating bridge rectifiers of the coil 106.

The high voltage coils 106 may have an air core, an iron core, or another type of core, and can include single, double, or multiple high voltage discharge coils arranged in a variety of topologies. For example, in a cylindrical topology, the secondary coils 106B and top loads can be inserted around and/or into the top and bottom of the cavity of the communication device 100. The top load are metal spheres or toroids connected to the secondary coils 106b to attract the signal for feedback. The primary coil 106A can then be wound around the framework encompassing the entire structure of the cavity of the device 100 in a cylindrical shape.

As another example, in a spherical topology, primary and secondary coils 106A and 106B can be spherically mounted. The top loads can be pointed into the center of the cavity of the communication device 100 and/or inserted into the top and bottom of the cavity. The primary coil 106A can be wound around the framework encompassing the entire structure of the cavity of the device 100 in a spherical shape.

As a third example, in a toroidal topology, the secondary coils 106B and the top loads can be mounted around and/or into the top and bottom of the cavity of the communication device 100. The primary coil 106A can then be wound around the framework encompassing the entire structure of the cavity of the device 100 in a toroidal shape.

As a fourth example, in a circular topology, a series of top and bottom pillars of the secondary coils 106B and center top loads can be circularly spaced apart from one another around and/or in the cavity of the communication device 100. The primary coil 106A can then be wound around the framework encompassing the entire structure of the cavity of the device 100 in any shape.

As to the inductor coils 104, they can include an innermost inductor coil 104A, one or multiple middle inductor coils 104B around the innermost inductor coil 104A, and an outermost inductor coil 104C around the middle inductor coils 104B. The innermost inductor coil 104A is inductively or conductively connected (e.g., by parasitic or link induction) to the central core 102.

The middle inductor coils 104B generate a constantly changing electromagnetic flux as the electromagnetic fields. As such, the middle inductor coils 104 impart gyroscopic spin to the central core 102 via the innermost inductor coil 104A. The outermost inductor coil 104C supports the innermost inductor coil 104A and the middle inductor coils 104B, and is inductively or conductively connected to the high voltage coils 106.

The inductor coils 104 can be connected electrically and mounted concentrically, rotating inside of one another to vary inductance and strength of the electromagnetic fields. The inductor coils 104 may be controlled independently of one another or linked together. The inductor coils 104 may be motorized or non-motorized, and/or may be able to freely move independently. The inductor coils 104 may be spun at the same speed or at different speeds, or may be stationary. The inductor coils 104 can spin for a specified amount of time, speed, and degrees of rotation. Electric motors and/or generators/alternators may be used in conjunction with the inductor coils 104 to ensure controlled spin, power/signal generation, and add torque to increase speed and overcome magnetic locking.

The inductor coils 104 can be toroidal in shape, or may have another shape. For example, the inductor coils 104 may be single ring, multiple ring, or spherical coils, as well as other shapes of coils. The inductor coils 104 can include circuits, laminated or coated conductor sheets, magnet wire, single wire conductor, and/or bifilar or multifilar wire. The inductor coils 104 can have an air or iron core, and be ferro fluid, liquid, or gas filled.

The inductor coils 104 can be core or air wound on a framework or be self-supported. If the coils 104 have a framework, the framework may be made from wood, metal, ferrites, crystals, silicon, plastics, rubber, foam, glass, reinforced concrete, ceramics, three-dimensionally (3D) printed material, cast material, or sintered material. The framework can thus include any material that a coil of wire can be wrapped around to give the resulting inductor coils 104 structure and strength.

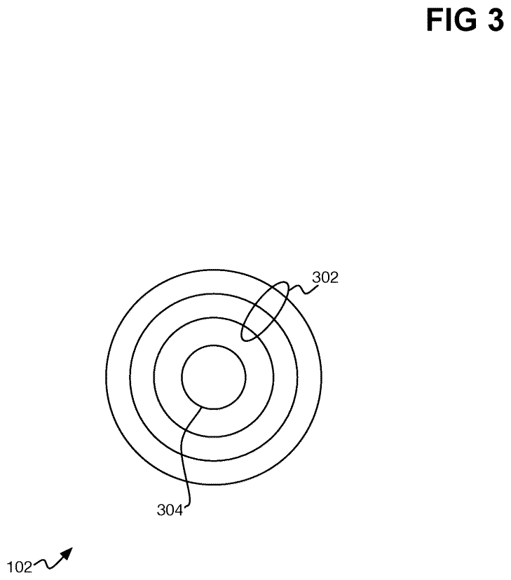

FIG. 3 shows an example of the central core 102. The central core 102 can include one or multiple nested inductor coils 302 around a material 304. In the depicted example, the inductor coils 302 are spherical. The inductor coils 302 produce a consistent state of magnetic flux inside and outside of the core 102 to trap the electromagnetic fields impart by the inductor coils 104 (which are not to be confused with the inductor coils 302 of the core 102).

In the case of signal transmission, the inductor coils 302 vary the inductance and strength of the electromagnetic fields imparted by the inductor coils 104, specifically according to the signal injected by the signal injection circuit 108. Such variation causes collapse of the electromagnetic fields within the material 304 according to the signal. In turn, collapse of the electromagnetic fields transmits particles and/or anti-particles from the material 304 according to the signal, resulting in transmission of the signal.

In the case of signal receipt, the material 304 receives particles and/or anti-particles that have been transmitted according to a signal, which results in receipt of the signal. Receipt of the particles and/or anti-particles collapses the electromagnetic field within the material 304 according to the signal. This electromagnetic field collapse varies the inductance and strength of the electromagnetic fields, which can then be detected by the signal detector circuit 110, such that the detector circuit 110 detects the signal.

The inductor coils 302 of the central core 102 may be spherical or another shape. The inductor coils 302 may be wrapped around a framework, which may be or include a hermetically sealed shell including the material 304. The inductor coils 302 can be inductively or conductively connected to the inductor coils 104, and may be non-motorized or motorized to overcome magnetic locking or cogging.

The central core 102 is mounted concentrically within the inductor coils 104, and can be connected electrically to the inductor coils 104. The central core 102 can have movable axis points with varying degrees of rotation that are free to rotate or that can be positionally controlled around the axis of the inductor coils 104. For instance, motors, pins, slots, gears, rollers, skates, fixed connection points, bearings, and/or slew bearings may be employed in this respect.

The central core 102 rotates within the modulated high voltage plasma and gyroscopic electromagnetic fields produced by the high voltage coils 106 and the inductor coils 104. The position of the central core 102 within these fields varies the inductance and strength of the modulated electromagnetic field within the core. Such variation produces a collapse of the fields within the core, sending particles and/or anti-particles from the material 304, as noted above.

The central core 102 may be open air or encased within one or multiple hermetically sealed shells corresponding to the inductor coils 302, in which case the material 304 is encased within the innermost hermetically sealed shell corresponding to the innermost inductor coil 302. As one example, the hermetically sealed shells can be glass spheres. Except for the innermost shell that encases the material 304, the hermetically sealed shells can be filled with liquids, gases, fluids, or a vacuum. The central core 102 may also include a spark transmitter, ions, charged particles, and subatomic particles.

The material 304 may be different types of crystals, gases or plasmas, liquids, metals, and chemical elements. A non-exhaustive list of examples includes, for instance, silicon, quartz, ruby, fluorite/fluorine, calcite, selenite, galena, spin glass, time crystals, hydrogen, tritium, argon, neon, nitrogen, oxygen, krypton, xenon, helium, hydrogen peroxide, water, deuterium, gallium, cesium, rubidium, mercury, metal lattice confinement, iron, nickel, gold, aluminum, copper, tungsten, carbon, graphite, graphene, borophene, beryllium, and phosphorous. The material 304 ejects particles and/or anti-particles. These particles and/or antiparticles interact with the high voltage plasma in the gyroscopic electromagnetic fields generated by the inductor coils 104 and the high voltage coils 106, as noted above.

Adjacent to the material 304 within the innermost inductor coil 302 of the central core 102 may be circuits to impart various physical (i.e., mechanical), electrical, and other forces on the material 304. Depending on the type of material 304 in question, such devices can include motors, gyroscopes, flywheels, inductors, capacitors, super capacitors, magnetrons, electroacoustic transducers, lasers, ferrite beads, lattices, magnets, and electrodes. As an example of the latter, electrodes may be used to pulse voltage through the material.

As noted above, for signal transmission, the signal injection circuit 108 of the omnidirectional communication device 100 introduces a signal into the device 100 in accordance with data to be transmitted. The signal injection circuit 108 may be or include an electron beam to deliver electrons as the signal. As another example, the signal injection circuit 108 may be or include a particle accelerator to deliver charged particles as the signal. As a third example, the signal injection circuit 108 may be or include a photonic emitter to deliver photons as the signal.

As also noted above, for signal receipt, the signal detector circuit 110 of the omnidirectional communication device 100 detects the signal as has been warped, and therefore detects the data in accordance with which the signal has been transmitted to the device 100. The signal detector circuit 110 can include either or both of a piezoelectric detector circuit and a silicon detector circuit. The signal detector circuit 110 may additionally or instead detect electrons, charged particles, or photons received by the central core 102 as the signal.

An omnidirectional communication device 100 has been described that can omnidirectionally transmit and receive data over great distances. The communication device 100 achieves this via a central core 102, inductor coils 104 surrounding the central core 102, and high voltage coils 106. In the case of signal transmission, rotation of the central core 102 and the inductor coils 104 within the plasma field generated by the high voltage coils 106 warp the signal, which causes the central core 102 to omnidirectionally transmit the signal outside the device 100. In the case of signal receipt, the central core 102 receives an omnidirectionally signal transmitted from outside of the device 100, which is warped via rotation of the central core 102 and the inductor coils 104 within the plasma field generated by the high voltage coils 106, and then detected.

Furthermore, in different implementations, the device 100 can produce and utilize fusion energy in accordance with magnetic confinement, inertial electrostatic confinement, and/or magneto-inertial fusion. In this case, heat resistant materials can be used as frameworks for the coils 104 and/or 106 and the entire device 100 may be encased in a fusion reactor shell. Also the central core 102 may be or include a fusion reactor in this implementation.

### Additional Embodiments and Improvements

The following embodiments, improvements, and alternative descriptions may include subject matter not present in the priority applications filed in 2021 and 2022, and therefore constitute new matter supported by this continuation-in-part application.

The device may employ primary field-generation excitation coils and secondary excitation coils that operate using high-energy excitation mechanisms rather than relying solely on high-voltage discharge modes. These coils may be energized through electromagnetic, photonic, inductive, plasma-driven, quantum-field, or hybrid excitation sources capable of generating, sustaining, or modulating the operative plasma field. The excitation coils may be tunable across wide frequency ranges, may support resonant or non-resonant operation, and may function as resonant transformers or dynamic excitation elements configured to couple energy into the central core, the inductor coils, or surrounding field-generation structures. These excitation modes may enable plasma formation, field modulation, signal transmission, or quantum-coupled interactions using low voltage, high voltage, or non-voltage excitation schemes.

The primary field-generation excitation coil(s), inductor coils, and central-core coils may be constructed in additional shapes including, but not limited to, polygonal coils, fractal coils, multi-lobed coils, conical coils, Möbius coils, figure-eight coils, double-helix coils, and hybrid composite coils combining toroidal and cylindrical elements.

Coils may be fabricated using flexible substrates, printed circuit board (PCB) windings, lithographically patterned films, conductive inks, 3D-printed metallic structures, superconductive filaments, metamaterial-based conductive pathways, photonic waveguide coils, or plasma-based virtual coils.

Coils may incorporate self-tuning or adaptive inductance technologies using MEMS actuators, piezoelectric strain modulators, electroactive polymers, or variable-permeability cores.

Beyond the described electromagnetic and electrostatic plasma fields, the device may utilize a wide range of hybrid confinement modes. These may include electron cyclotron resonance (ECR) plasma, inductively coupled plasma (ICP), helicon wave plasma, microwave-induced plasma, dielectric-barrier discharge plasma, cold atmospheric plasma, magneto-optical trap plasmas, and quantum-gas condensates such as Bose-Einstein or Fermi-degenerate gases. Each of these confinement modes may be selected based on desired operating frequency, stability requirements, or communication throughput.

The system may also employ alternative field topologies, which may include quadrupole, octupole, or other multipole magnetic traps; toroidal rotational fields with nested or multi-axis rotational structures; spiral or vortex-induced plasma flow patterns; polarized photon confinement fields; magnetic potentials arranged in gradient or staircase configurations; and time-varying electrostatic funnels designed to direct or compress plasma regions within the core.

Signal injection may be accomplished using a variety of electromagnetic, photonic, quantum, acoustic, or particle-based sources. These may include quantum-cascade lasers, tunable diode lasers, spin-polarized electron emitters, ultrasonic or hypersonic transducers, terahertz radiation sources, field-emission electron arrays, optomechanical modulators, or graphene-based terahertz antennas. These injection sources may be selected to optimize coupling efficiency with the plasma field or central core.

Signal detection may be performed using quantum photodetectors, transition-edge sensors, cryogenic bolometers, nitrogen-vacancy (NV) diamond magnetometers, plasma-wave detectors, or high-temperature superconducting pickup loops. These detection systems may be tailored to the spectral range, field topology, or resonance condition of the transmitted signal.

Signals may be modulated using amplitude, phase, frequency, spin state, orbital angular momentum, polarization, quantum entanglement phenomena, or time-reversal symmetry modulation. These modulation techniques may operate individually or in combination to enhance bandwidth, improve noise immunity, or increase transmission speed.

The central core may incorporate a wide range of advanced materials, including quantum dots, excitonic or polaritonic media, superfluids, high-k dielectric materials, spintronics-based substrates, two-dimensional materials such as graphene, molybdenum disulfide (MoS₂), hexagonal boron nitride (h-BN), or phosphorene, as well as hyperbolic metamaterials, magneto-optic crystals, and metal-organic frameworks. These materials may provide enhanced interaction with electromagnetic fields or support unique resonance conditions.

The hermetically sealed core chamber may contain mixtures of gases, plasmas, suspended particles, nanoparticle colloids, supercritical fluids, or reactive chemical species selected to improve internal field stability, increase transmission efficiency, or optimize the device for specific environmental conditions.

The central core and surrounding coils may rotate along one or multiple axes to modulate the field geometry or enhance resonance effects. Rotation may include synchronized counter-rotation between separate elements, precessional rotation around a shifted longitudinal axis, gyroscope-assisted rotation to maintain stability, dynamically shifting rotational axes to tune resonance modes, or controlled vibration-based micro-rotation for fine modulation.

The rotation may be driven by electromagnetic forces, piezoelectric actuation, acoustic levitation arrays, magnetohydrodynamic thrust mechanisms, electrostatic repulsion forces, or conventional mechanical motors. Any of these mechanisms may be used independently or in combination to achieve the desired rotational profile.

The device may incorporate advanced computing systems to optimize performance, including machine-learning-based optimization engines, adaptive control circuitry, FPGA or ASIC-based modulation processors, quantum-computing interfaces, AI-driven frequency-selection algorithms, and autonomous calibration subsystems. These processing units may continually monitor operating conditions and adjust device parameters for improved stability and precision.

The feedback system may monitor plasma density, temperature gradients, electromagnetic flux distribution, quantum coherence levels, core rotational stability, and field-collapse signatures. By analyzing these parameters in real time, the device may perform adaptive modulation, automatically adjusting operational parameters to maintain optimal signal transmission and resonance conditions.

In addition to the fusion-related processes previously described, the device may incorporate alternative energy-generation modes, including Z-pinch confinement, field-reversed configurations (FRCs), micro-fusion spark chambers, laser-assisted fusion initiation techniques, and thermionic or pyroelectric fusion triggers. These modes may be used to support internal plasma formation or to power secondary systems.

Energy harvested from fusion or fusion-hybrid events may be used to energize onboard circuitry, sustain plasma confinement conditions, modulate electromagnetic fields, or support auxiliary subsystems requiring high-density power.

The device may be miniaturized into portable, wearable, implantable, drone-mounted, satellite-borne, sub-surface, underwater, or autonomous-vehicle-integrated forms. Miniaturization may be achieved through microfabrication, advanced materials, or integrated circuitry optimized for reduced size and weight.

Multiple devices may form a mesh, distributed, relay, or swarm-based communication network to enhance signal propagation, provide redundancy, or enable coordinated multi-node communication across large distances or challenging environments.

The device may be used in a wide variety of applications, including deep-space communication, subterranean transmission, underwater communication, quantum-secure communication, communication through dense or electrically shielded media, operation in high-radiation environments, operation within high-temperature plasma reactors, GPS-denied navigation scenarios, fusion-reactor diagnostics, and distributed sensor networks designed for extreme planetary or interplanetary environments.

In certain embodiments, the signal injection and detection subsystems may utilize optical and atomic devices including gas lasers, solid-state lasers, fiber lasers, dye lasers, and semiconductor lasers operating as optical gain media for the generation, amplification, or modulation of photons used as the signal. The central core, the surrounding coils, or external modules may house atomic ensembles or vapor cells containing, for example, alkali vapors or other atomic species configured to interact with the electromagnetic fields or plasma fields of the device to support high-sensitivity detection or coherent control of the signal.

In further embodiments, the signal detector circuit may incorporate optically pumped magnetometers, including but not limited to alkali-vapor optically pumped magnetometers, spin-exchange relaxation-free magnetometers, and related atomic magnetometric devices that sense changes in magnetic fields produced by the signal, the plasma, or the motion of charged particles within the central core. These magnetometers may operate in conjunction with or as alternatives to magnetometers, magnetic pickups, inductive sensors, and resonant coil antennas described elsewhere in the specification.

The device may further include linear and nonlinear electronic or optical elements, including resistive, capacitive, and inductive components, as well as nonlinear diodes, varactors, tunnel diodes, Josephson junctions, parametric amplifiers, and nonlinear optical crystals. These elements may be arranged in high-frequency circuits, oscillators, or resonant cavities to shape, mix, up-convert, down-convert, or otherwise process the signal prior to injection into or after detection from the central core.

In particular embodiments, the photonic or quantum-optical sub-systems may employ nonlinear optical processes such as spontaneous parametric down-conversion, four-wave mixing, sum-frequency generation, difference-frequency generation, and optical parametric oscillation to generate entangled photon pairs, squeezed states of light, or other nonclassical optical states used for quantum-enhanced communication, sensing, or encryption. These processes may occur within or in optical communication with the central core, the surrounding coils, or ancillary optical cavities coupled to the device.

In addition to the plasma modes previously described, the device may employ exotic plasmas including glow-discharge plasmas, electrodeless discharge plasmas, radio frequency or microwave-sustained plasmas, and mixed-mode plasmas that combine one or more of these discharge mechanisms. Electrodeless discharge configurations may be implemented using inductive or capacitive coupling to sustain plasma within the central core or within auxiliary chambers without direct electrode contact, thereby reducing electrode erosion and contamination.

In some embodiments, the device may be configured for telluric communication, in which the signal is coupled into and extracted from the Earth, rock, soil, ice, ocean, or other conductive or semi-conductive media. The inductor coils, field-generation excitation coil(s), and central core may be driven to generate fields that interact with telluric currents, Schumann resonances, or other Earth-coupled modes, enabling communication through underground, underwater, or shielded environments where conventional radio-frequency links are attenuated or unavailable. In such implementations, the device may operate in conjunction with buried electrodes, grounded structures, or remote nodes that are similarly configured to couple into the same telluric pathways.

In addition to the cylindrical and toroidal geometries described in earlier embodiments, the central core, the surrounding coils, the plasma chamber, and the resonance structures may be formed in numerous alternative shapes. The central core may be implemented as a sphere, ellipsoid, cube, rectangular prism, triangular prism, polyhedron, capsule, oblate or prolate spheroid, or any other three-dimensional geometry suitable for sustaining electromagnetic or plasma-based resonance. The selected geometry may influence the distribution of internal fields, resonance quality factors, and the behavior of charged particles or photons within the core.

The coils that surround the central core may likewise adopt a variety of shapes. These coils may be circular, elliptical, polygonal, triangular, square, pentagonal, hexagonal, octagonal, or irregular in cross-section. They may also be configured as spirals, helices, double helices, Möbius coils, figure-eight coils, conical coils, saddle coils, spherical coils, solenoids, or fractal coils. Each coil geometry may produce distinct inductive, capacitive, or field-distribution characteristics that enable the system to operate at different frequencies, bandwidths, and resonance conditions.

In certain embodiments, the device may use nested geometries in which the core has one shape while the surrounding coils adopt a different one. For example, a spherical core may be surrounded by a toroidal coil, or a cubic core may be coupled with circular coils positioned on each face. These mixed-geometry systems may enable hybrid field modes or spatially varying resonance regions useful for sensing, communication, or field manipulation.

The internal plasma region or atomic ensemble within the central core may also take on different shapes depending on the applied fields, confinement method, or internal pressure. Plasma may be confined in spherical shells, toroidal rings, hourglass structures, vortex columns, spiraling filaments, or flattened disc-like formations. These plasma shapes may be produced through dynamic field modulation, multi-axis rotation, or geometric chamber design.

In some embodiments, the entire device may be constructed in a geometry optimized for integration with environments or platforms. The device may be flattened into a planar or disc shape for integration into surfaces; elongated into a rod, staff, or baton shape for directional field emission; miniaturized into a rectangular or cylindrical module for portable systems; or expanded into a spherical or icosahedral configuration for omnidirectional communication or sensing.

Resonance cavities, optical cavities, and quantum chambers used within the device may likewise adopt specialized geometries including Fabry-Perot cavities, spherical resonators, ring resonators, whispering-gallery-mode resonators, bowtie cavities, and distributed Bragg reflector cavities. Each geometry may support distinct standing-wave patterns, optical path lengths, or quantum coherence characteristics that influence the device's performance.

The shapes of electrodes, field emitters, photonic couplers, antennas, and sensor arrays may also vary widely. Antenna structures may be linear, looped, spiral, helical, log-periodic, fractal, horn-shaped, conical, or spherical. Electromagnetic input and output ports may be arranged in symmetrical or asymmetrical patterns, radial arrays, linear arrays, curved arrays, or volumetric distributions optimized for specific propagation modes.

In still further embodiments, the structural housing of the device may adopt organic or biomimetic geometries such as branching tree-like structures, honeycomb lattices, Voronoi patterns, or surfaces with curvature inspired by biological or geological forms. These structures may improve heat dissipation, electromagnetic transparency, structural rigidity, or vibrational damping.

In certain embodiments, the device may incorporate advanced computational frameworks that operate using vector mathematics, matrix operations, tensor algebra, and higher-order multidimensional arrays. These mathematical structures may be used to model electromagnetic fields, predict plasma dynamics, optimize coil currents, solve boundary-value problems, adjust modulation schemes, or compute field-interaction parameters in real time.

The system may utilize Fourier-based analysis including discrete Fourier transforms, fast Fourier transforms, continuous Fourier transforms, multidimensional Fourier transforms, and quantum Fourier transforms. These transforms may be used to analyze spectral components of the transmitted or received signal, to shape waveform envelopes, to perform noise filtering, or to identify resonance peaks associated with the plasma or atomic ensemble within the core.

In further embodiments, the device may employ alternative integral transforms including Laplace transforms, inverse Laplace transforms, Hilbert transforms, Z-transforms, Mellin transforms, Radon transforms, and wavelet transforms. These transforms may be used to characterize transient phenomena, reconstruct signals from incomplete datasets, analyze field propagation through nonlinear media, or extract features relevant to quantum or classical communication.

The device may operate within computational spaces including k-space, reciprocal space, Fourier space, Hilbert space, configuration space, phase space, and other mathematical or physical domains used to represent wavefunctions, momentum distributions, electromagnetic modes, or plasma field geometries. The transformation between these spaces may enable enhanced control of signal routing, optimization of field stability, or improved detection accuracy.

Machine-learning subsystems or deterministic optimization engines associated with the device may perform eigenvalue and eigenvector calculations, singular-value decomposition, spectral decomposition, principal component analysis, nonlinear regression, gradient-descent optimization, or reinforcement-learning operations. These computations may be used to tune coil currents, adjust plasma parameters, enhance modulation depth, minimize interference, or maintain stable oscillation conditions within the device.

Quantum-computing interfaces, when used, may operate using qubits, multi-qubit entanglement, quantum gates, quantum measurement operators, and unitary transformations that act in Hilbert space. In such embodiments, quantum algorithms may be used to optimize resonance conditions, identify stable communication channels, process entangled-photon pairs, or accelerate calculations that would be computationally intensive in classical systems.

In still further embodiments, the device may include computational models based on partial differential equations, nonlinear dynamical systems, stochastic differential equations, or finite-element methods. These models may simulate plasma behavior, predict field interactions, or control time-dependent modulation schemes. The system may solve these equations locally using embedded processors or remotely using cloud-based or quantum-enhanced computational resources.

The architecture may additionally incorporate operator theory, functional analysis, tensor-field mapping, differential-geometry frameworks, and higher-dimensional manifolds when describing or controlling electromagnetic field propagation, plasma confinement, or atomic coherence phenomena. These mathematical representations may be used to analyze curvature effects in field topology, to describe the evolution of quantum states, or to model the interaction of fields in complex geometries.

The embodiments described herein are illustrative rather than limiting, and the atomic resonance communication device may be implemented using any combination of the materials, geometries, circuits, computational methods, plasma modes, resonant structures, sensing systems, or operational techniques described above. All features disclosed in one embodiment may be combined with any other embodiment unless expressly stated otherwise. Variations in scale, proportion, topology, composition, or configuration shall be considered within the scope of the present specification. The device may further include functional equivalents, substitutions, or technological successors to any component or method described herein, including future materials, quantum-optical devices, computational models, or plasma technologies not yet commercially available but functionally analogous to those detailed above.

In certain embodiments, the atomic resonance communication device may utilize exotic or non-conventional signaling modalities in addition to electromagnetic, photonic, acoustic, and particle-based systems. These exotic communication pathways may include, but are not limited to, communication based on gravitational perturbations, density-modulated inertial waves, neutrino-based signaling, muon-modulated signals, or interactions with cosmic-ray flux. These modes may be generated by modulating the plasma field, the rotation of the central core, or the electromagnetic fields of the coils to impart changes detectable by remote devices configured to sense such exotic phenomena.

Gravitationally coupled communication may be achieved by modulating mass distribution or plasma density within the core or resonance cavity, producing small but detectable variations in gravitational potential or spacetime curvature. Neutrino or muon-based communication may be implemented through particle interaction chambers, electroweak field modulators, or hybrid plasma-particle interfaces incorporated into the central core or surrounding coils. These modes may be selected for environments where electromagnetic communication is limited or attenuated.

The communication device may incorporate meta-materials or engineered materials that possess tunable electromagnetic or optical properties, including artificial permittivity, artificial permeability, negative refractive index, or anisotropic or hyperbolic dispersion profiles. These meta-materials may be integrated into the resonant cavity, coil framework, central core shell, or external housing.

In certain embodiments, programmable meta-surfaces may be used to dynamically redirect, focus, phase-shift, or shape electromagnetic fields emitted or received by the device. Such meta-surfaces may be reconfigured electronically, optically, thermally, acoustically, chemically, or via AI-controlled feedback mechanisms.

Additional embodiments may employ field-shaping structures such as gradient-index lenses, transformation-optics devices, cloaking layers, beam-steering arrays, or adaptive antenna sheets to control propagation direction, field confinement, or signal extraction.

The components of the atomic resonance communication device may be manufactured using any suitable fabrication method, including but not limited to: photolithography, electron-beam or ion-beam lithography, atomic layer deposition, vacuum deposition, chemical vapor deposition, nanoimprint lithography, microfabrication, MEMS/NEMS processes, direct-write conductive printing, additive manufacturing (3D printing), selective laser sintering, fused filament fabrication, or hybrid subtractive-additive processes.

Coils and resonant structures may be fabricated using printed circuit board (PCB) techniques, rolled or deposited thin films, laser-sintered metals, superconducting tapes, or 3D-printed conductive composites. Fabrication methods may also include the use of flexible substrates, transparent conductive films, or monolithic integrated photonic or electronic structures.

In additional embodiments, the device may be produced using scalable industrial manufacturing techniques for high-volume production or specialized precision fabrication methods for laboratory, aerospace, cryogenic, or quantum-communication applications.

The atomic resonance communication device may be adapted for operation in extreme or unconventional environments. These environments may include deep ocean, sub-surface geological layers, highly conductive rock strata, cryogenic environments, high-vacuum space, lunar regolith, Martian atmosphere, Venusian high-temperature zones, polar ice caps, radiation belts, fusion-reactor chambers, or environments with strong electromagnetic interference.

Environmental adaptation may be achieved through thermal shielding, radiation-hardened materials, cryogenic-compatible components, high-pressure housings, plasma-resistant ceramics, electromagnetic shielding layers, or inert-gas-filled shells. The device may autonomously detect environmental conditions and dynamically adjust operational parameters such as frequency, modulation scheme, power level, confinement topology, or coil-current distribution.

In addition to fusion-related energy modes, the communication device may incorporate advanced or speculative energy-harvesting methods including zero-point energy harvesting, Casimir-effect-based power extraction, vacuum-fluctuation coupling, thermophotovoltaic harvesting, betavoltaic or radiovoltaic power systems, triboelectric generators, pyroelectric or piezoelectric arrays, or magnetohydrodynamic converters.

Energy harvested from resonant fields, plasma oscillations, mechanical rotation, pressure gradients, or environmental sources may power signal injection, detection, computation, field modulation, or auxiliary onboard systems.

The device may be integrated into hybrid classical-quantum communication architectures. Such architectures may employ entangled photon pairs, squeezed-light states, quantum repeaters, or distributed quantum nodes for secure communication or enhanced sensing.

In certain embodiments, the device may communicate with quantum computers, quantum processors, ion traps, NV-center arrays, superconducting qubits, or photonic integrated circuits. These quantum subsystems may assist with frequency optimization, signal interpretation, entanglement generation, error correction, or resonance-dynamics prediction.

Hybrid networks may include satellite-based quantum uplinks, ground-based quantum channels, free-space optical quantum links, or entanglement-distribution systems connecting multiple atomic resonance communication devices.

The device may incorporate artificial intelligence systems, machine-learning models, or autonomous optimization engines to dynamically control internal fields, plasma characteristics, rotation profiles, coil currents, or resonance conditions. AI systems may be trained using reinforcement learning, genetic algorithms, neural networks, or hybrid symbolic-neural models.

A digital twin of the device may operate in real time, simulating plasma dynamics, electromagnetic interactions, resonance modes, quantum processes, or structural stress conditions. The digital twin may enable predictive tuning, self-correction, system calibration, anomaly detection, or resilience optimization.

The device may autonomously adjust operating parameters to compensate for environmental changes, component aging, manufacturing variations, or mission-specific requirements.

Beyond previously described plasmas, the device may incorporate or interact with alternative forms of matter including supercritical fluids, exotic plasmas, dusty plasmas, pair plasmas, electron-positron plasmas, warm dense matter, quark-gluon-like plasma states, or magnetorheological or electrorheological fluids.

These media may influence, stabilize, or enhance resonance conditions, field confinement, or signal propagation. Chambers containing such media may be hermetically sealed or dynamically replaced during operation.

Multiple devices may form distributed communication networks, mesh networks, swarm architectures, or cooperative multi-node systems. These networks may employ synchronized resonance modes, frequency-agile routing, swarm intelligence algorithms, or redundant pathways to achieve high reliability, long-distance coverage, or communication through obstructed environments.

Nodes may be static, mobile, aerial, underwater, underground, spaceborne, or planetary-networked across heterogeneous environments.

Any element, subsystem, material, geometry, computational method, plasma mode, cavity structure, or operational technique described in any embodiment may be combined with any other embodiment unless explicitly stated otherwise. Variations in scale, proportion, topology, or configuration shall not depart from the scope of this specification.

Future materials, sensing systems, optical devices, quantum technologies, computational frameworks, manufacturing processes, or plasma techniques that are functionally analogous to those described herein are included within the scope of the present disclosure, even if not commercially available at the time of filing.

In certain embodiments, the atomic resonance communication device may incorporate or interface with bio-inspired, organic, or living-material systems to enhance sensing, adaptability, or environmental responsiveness. These materials may include living polymers, conductive biofilms, ionically conductive tissues, biomimetic gels, enzyme-responsive substrates, bio-luminescent materials, or hybrid organic-inorganic composites configured to participate in signal generation, modulation, or detection.

Bio-based sensing elements may include ion-channel networks, neuron-like conductive pathways, artificial synapse structures, bioelectrical membranes, voltage-gated molecular systems, or enzymatic modulators configured to shift resonance, impedance, or field response based on environmental conditions or biochemical interactions. These systems may exhibit adaptive, self-healing, regenerative, or learning characteristics that enable the communication device to function autonomously in dynamically changing or extreme environments.

Organic and bio-hybrid components may further include genetically engineered materials, synthetic biological lattices, microfluidic biochemical chambers, cellular matrices, or metabolically active structures capable of modifying, amplifying, or filtering electromagnetic, ionic, thermal, or photonic signals.

In certain embodiments, the communication device may utilize gravito-electromagnetic coupling, inertial-field modulation, or space-time interaction effects to facilitate communication, sensing, field stabilization, or resonance enhancement. These systems may include structures configured to interact with frame-dragging effects, Lense-Thirring rotational fields, inertial tensor gradients, or variations in local gravitational potential.

Modulation may be achieved through controlled mass redistribution, plasma density adjustments, rotational acceleration, dynamic field gradients, or structural deformation of resonant elements. These changes may induce detectable perturbations in the surrounding inertial or gravitational field that can be sensed by remote systems equipped with high-sensitivity gravimetric detectors, inertial sensors, or hybrid quantum sensors.

In additional embodiments, the device may utilize Mach-effect responses, gravitational shielding analogues, or spacetime-metric perturbation encoding to enable communication through dense materials, planetary bodies, or interference-dominated environments. Such modes may operate independently or in combination with electromagnetic, photonic, or quantum communication channels.

In certain embodiments, the communication device may incorporate advanced security, encryption, and anti-interference mechanisms using classical, quantum, or hybrid cryptographic frameworks. Communication may be encoded using quantum key distribution, entanglement-based authentication, non-repeating modulation signatures, frequency-agile encoding, or dynamic waveform morphing to ensure confidentiality and resilience.

The device may additionally employ electromagnetic cloaking layers, metamaterial-based shielding, plasma shielding envelopes, or noise-canceling field geometries to suppress detection by unauthorized receivers. Signal paths may utilize jamming-resistant encoding, spread-spectrum modulation, adaptive frequency hopping, resonance shifting, temporal scrambling, or stochastic waveform variation.

In further embodiments, the communication device may identify and counteract external interference sources using AI-driven anomaly detection, autonomous threat-response algorithms, real-time spectral analysis, or predictive modeling. These systems may dynamically adjust operational parameters to maintain communication integrity under hostile, contested, or high-interference conditions.

In some embodiments, the resonant medium comprises liquid-phase materials, including aqueous solutions, electrolyte solutions, sugar-water mixtures, optically active liquids, Raman-active liquids, colloidal suspensions, nanoparticle colloids, or liquids containing dissolved crystals or photonic additives configured to modify refractive index, absorption, scattering, or electromagnetic resonance characteristics.

In some embodiments, the multimodal Multiphysics excitation subsystem further comprises optical pump lamps, including xenon flash lamps, krypton arc lamps, or continuous-wave discharge lamps configured to deliver broadband or narrowband optical pumping energy to the resonant medium, the optical cavity, or the optical gain material. The pump lamps may be used for stimulated emission initiation, plasma pre-ionization, thermal conditioning, nonlinear-optical activation, or enhancement of resonant-field interactions.

In certain embodiments, rotation of the core is not required, and the system may instead employ dynamic field-based signal modulation produced by electromagnetic, optical, plasma, acoustic, or hybrid field interactions. Dynamic field-based signal modulation may occur through electromagnetic, optical, plasma, or hybrid field interactions within the resonant medium, the optical cavity, or the magnetometric sensing region, enabling modulation without mechanical rotation.

Referring now to FIG. 4, in certain embodiments, the device includes a multimodal resonant chamber 402 that houses multiple nested resonance regions. The chamber 402 may include an intermediate resonant region 404 and an inner resonant region 406, each configured to support electromagnetic, optical, plasma, acoustic, or hybrid field interactions. The regions 404 and 406 may contain gases, vapors, plasmas, optical gain materials, nonlinear crystals, or hybrid multimodal media to facilitate resonance-based communication, sensing, or field modulation.

The excitation subsystem 420 may include one or more energy sources that provide electromagnetic, optical, acoustic, plasma-based, or particle-based excitation to the resonant chamber 402. The subsystem 420 may operate continuously or in pulsed modes to initiate, sustain, or modulate resonance conditions within regions 404 and 406.

The multimodal excitation subsystem may include an optical pump source 420A, an RF/EM excitation driver 420B, an acoustic driver 420C, and a particle or ion emitter 420D. These subsystems may operate independently or cooperatively to energize the resonant chamber 402, induce field interactions, or modulate the signal transmitted or received by the device.

The device may further include one or more optically pumped magnetometers 412 configured to detect magnetic-field variations, resonance signatures, or plasma-field perturbations associated with signal transmission or reception. The magnetometer 412 may be positioned adjacent to the resonant chamber 402 or integrated into an associated optical cavity.

An optical cavity 410 may be positioned in optical communication with the resonant chamber 402 and may include reflective or refractive structures configured to interrogate the resonant medium using photonic or laser-based excitation.

A field-based modulation controller 430 may be provided to modulate magnetic fields, optical phase, plasma density, acoustic fields, or other field parameters to encode or manipulate data. The controller 430 may operate independently or in conjunction with the excitation subsystems.

A programmable multiphysics controller 460 may coordinate the operation of the excitation subsystems, modulation systems, and sensing systems. The controller 460 may execute algorithms for adaptive tuning, resonance optimization, signal shaping, and real-time field management across electromagnetic, photonic, plasma, acoustic, or hybrid domains.

The excitation subsystems and controllers 430 and 460 may be operatively coupled to the signal injection circuit 108 and the signal detector circuit 110 to facilitate multimodal communication.

In certain embodiments, the device includes one or more radiating elements configured for electromagnetic, optical, plasma-wave, acoustic, or particle-based transmission and reception, operatively coupled to the coil systems and resonant medium.

While specific embodiments have been illustrated and described, it will be understood that numerous modifications, variations, substitutions, and equivalents may be made without departing from the spirit and scope of the invention as defined by the claims. All such variations are intended to be included within the scope of this disclosure.

1. A multimodal resonant communication and sensing device configured to generate, sustain, and modulate resonance within a resonant medium, the device comprising:
(a) a resonant enclosure, cavity, or field-defined region that contains or defines a resonant medium capable of supporting at least two of the following interactions: electromagnetic, optical, plasma, acoustic, particle, quantum, or hybrid energy-field interactions;
(b) one or more field-generation structures configured to produce electric, magnetic, electromagnetic, optical, acoustic, plasma-based, particle-based, or hybrid excitation fields that interact with the resonant medium;
(c) one or more interrogation structures comprising an optical cavity, photonic resonator, magnetometer, optical sensor, electromagnetic sensor, plasma sensor, particle-detection structure, or a functional equivalent, the interrogation structures being configured to detect resonance-induced variations in at least one physical parameter of the resonant medium;
(d) a modulation subsystem configured to vary at least one excitation-field parameter or medium parameter to encode or alter a communication or sensing signal; and
(e) a transceiver subsystem configured to transmit or receive a signal modulated by resonance-induced changes within the resonant medium.

2. A multimodal resonance system comprising a resonant medium and a plurality of excitation fields that interact simultaneously or sequentially to produce a modulated resonance state that encodes information detectable by at least one sensing structure.

3. A resonant communication device comprising a resonant medium and at least one dynamic field source configured to generate a spatially or temporally varying multimodal resonance detectable outside the resonant medium.

4. A multimodal resonant communication apparatus comprising means for generating excitation fields, means for modulating the excitation fields, means for detecting resonance-induced variations, and means for transmitting or receiving a resonance-encoded signal.

5. The device of claim 1, wherein the resonant enclosure comprises a cylindrical, spherical, tubular, toroidal, freeform, or nested cavity containing a plasma, gas-laser medium, nonlinear crystal, or hybrid optical-plasma material.

6. The device of claim 1, wherein the optical cavity is configured for stimulated emission, optical gain, frequency conversion, or spontaneous or parametric photon generation.

7. The device of claim 1, wherein the field-generation structures comprise Helmholtz, anti-Helmholtz, Maxwell, quadrupole, octupole, saddle, solenoid, racetrack, cusp-field, or hybrid electromagnetic-coil configurations.

8. The device of claim 1, wherein the resonant medium supports plasma oscillations, electron or ion cyclotron resonance, magneto-optical resonance, or combinations thereof.

9. The device of claim 1, wherein the optical cavity comprises a Fabry-Perot cavity, ring resonator, distributed Bragg reflector cavity, or photonic-crystal cavity.

10. The device of claim 1, wherein the interrogation subsystem comprises an optically pumped magnetometer selected from SERF, Mx, or Bell-Bloom configurations.

11. The device of claim 1, further comprising nonlinear optical media selected from BBO, KTP, LiNbO₃, gallium arsenide, or functional equivalents.

12. The device of claim 1, wherein the excitation subsystem includes laser pumping, RF injection, high-voltage pulsed excitation, acoustic drive, or combinations thereof.

13. The device of claim 1, wherein the transceiver subsystem utilizes optical, RF, plasma-wave, quantum, particle-based, or hybrid detection modalities.

14. The device of claim 1, wherein the resonant medium comprises noble gases, alkali vapors, molecular gases, crystal rods, glasses, gas-laser mixtures, or liquid-phase materials including aqueous solutions, electrolytes, colloids, nanoparticle suspensions, or mixtures with dissolved optical or crystalline components.

15. The device of claim 1, wherein the optical cavity is pumped using diode lasers, fiber lasers, solid-state lasers, xenon flash lamps, krypton lamps, or continuous-wave discharge lamps.

16. The device of claim 1, wherein quantum-coherent interactions comprise at least one of entanglement, squeezing, quantum beats, or parametric coherences, the quantum beats including oscillatory interference effects arising from a coherent superposition of energy states, time-domain modulation of resonance signals caused by interference between multiple resonant transitions, or coherence-induced modulation between closely spaced or nearly degenerate levels of the resonant medium.

17. The device of claim 1, wherein piezoelectric, acoustic, magnetic, electromagnetic, or electromechanical structures deliver synchronized pulsed fields for particle manipulation or charged-particle acceleration.

18. The device of claim 1, further comprising an electron-emission structure selected from thermionic emitters, field-emission sources, x-ray sources, or photoemission sources.

19. The device of claim 1, wherein particle beams or charged-particle streams are modulated in amplitude, frequency, phase, or density to encode communication or sensing signals.

20. The device of claim 1, wherein fusion-support elements comprise magnetic pinch structures, inertial confinement structures, magnetic confinement structures, optical-heating arrays, or acoustic-compression mechanisms.

21. The device of claim 1, further comprising a controller configured to adjust excitation-field parameters, medium parameters, or transceiver settings in real time to optimize resonance conditions, communication performance, sensing accuracy, or resonant-medium stability, the controller being further configured to:
receive interrogation data from the interrogation subsystem;
compute resonance-state metrics or predictive models; and
autonomously tune modulation parameters based on the computed metrics,
the controller being local, distributed, remote, cloud-based, embedded in software, or implemented via machine-readable instructions executed on external hardware.

22. The device of claim 1, wherein the field-generation structures produce standing, rotating, or spatially varying magnetic, optical, plasma, or hybrid fields.

23. The device of claim 1, wherein the transceiver extracts data encoded through plasma-frequency shifts, magneto-optical rotation, optical-phase modulation, or hybrid field interactions.

24. The device of claim 1, wherein the resonant enclosure includes optical windows, metamaterial apertures, or photonic interfaces.

25. The device of claim 1, further comprising fiber-optic coils configured for interferometric sensing, photon detection, phase detection, polarization modulation, distributed sensing, or optical delay.

26. The device of claim 1, further comprising optical sensors selected from photodiodes, avalanche photodiodes, interferometric detectors, fiber-Bragg-grating sensors, or integrated photonic detectors.

27. The device of claim 1, further comprising shielding structures comprising borosilicate, fused silica, ceramics, or radiation-resistant composite materials.

28. The device of claim 1, further comprising one or more radiating elements configured to transmit or receive electromagnetic, optical, acoustic, plasma-wave, particle-based, or hybrid multimodal communication signals.

29. The device of claim 28, wherein the radiating element comprises a conductive radiator, optical emitter, photonic antenna, metamaterial aperture, plasma radiator, acoustic transducer, charged-particle emission structure, or a hybrid multimodal radiating structure.

30. The device of claim 1, further comprising a signal-injection circuit configured to introduce electrical, optical, plasma-based, acoustic, or particle-based modulation signals into the resonant medium, wherein dynamically varying multimodal fields modulate the transmitted or received signal, and wherein operation of the device comprises:
(a) generating at least one excitation field within or around the resonant medium;
(b) inducing a multimodal resonance state within the resonant medium;
(c) modulating at least one excitation-field parameter or medium parameter to encode information;
(d) detecting resonance-induced variations using the interrogation subsystem; and
(e) transmitting or receiving a resonance-encoded communication or sensing signal.

31. The device of claim 1, wherein the interrogation subsystem further comprises at least one inductive pickup coil configured to detect resonance-induced variations in magnetic flux, induced current, field gradients, or time-varying electromagnetic fields.
